(19) United States
(12) Patent Application Publication
(10) Pub. No.: US 2012/0120108 A1
(43) Pub. Date: May 17, 2012

(54) NAVIGATION SYSTEM

(76) Inventors: Peter Roessger, Aichtal (DE); Olaf Preissner, Kirchheim unter Teck. (DE); Bianca Foerster, Heimsheim (DE)

(21) Appl. No.: 13/296,948

(22) Filed: Nov. 15, 2011

(30) Foreign Application Priority Data
Nov. 15, 2010 (EP) 10 191 178.2

(51) Int. Cl. G09G 5/00

(52) U.S. Cl. 345/635; 345/634

(57) ABSTRACT

A navigation system comprises a map memory, a processing device and a display. The processing unit is configured to simultaneously display a first portion of a map stored in the map memory using a first perspective and a second portion of the map using a second perspective different from the first perspective on the display.

### 1. CLAIM OF PRIORITY

This patent application claims priority from EP Application No. 10 191 178.2 filed Nov. 15, 2010, which is hereby incorporated by reference.

### 2. FIELD OF TECHNOLOGY

The application relates to navigation systems and corresponding methods for displaying maps on navigation systems.

### 3. RELATED ART

Navigation systems are commonly used to help finding a way to a specific location. Such navigation systems may, for example, be used in cars or other automobiles, but may also be used for other vehicle like airplanes or also for pedestrians.

Many navigation systems comprise a display on which a map of the area surrounding of the user of the navigation system, e.g., of the vehicle, is displayed in some manner, and a route to be taken may be highlighted in the map. One common way to display such maps is a two-dimensional display, i.e., the map is displayed from a bird's eye view. In such cases, a rather large part of the surroundings of a user can be shown and previews for larger distances are possible.

Another way to display maps is in a three-dimensional view, for example, from a perspective at least approximating the real perspective of the user of the navigation system. This display is generally more intuitive and better suited to provide a user with more detailed information on the streets, buildings and/or point of interests around the user. On the other hand, generally a smaller part of the surroundings of the user can be displayed. Previews for larger travelling distances are hard to realize.

Therefore, a need exists for improved ways of displaying maps on navigation systems and corresponding navigation systems.

### SUMMARY OF THE INVENTION

A method according to an aspect of the present invention comprises simultaneously displaying a first portion of a map using a first perspective and displaying a second portion of the map using a second perspective different from the first perspective.

By displaying different portions of a map using different perspectives, advantages of different perspectives as regards, for example, the capability of providing an overview or an intuitive display of a map may be combined.

The first portion and the second portion may be adjacent portions of the map and may be displayed adjacent to each other, in particular as being merged at a common border, such that essentially a single map is displayed with different perspectives.

The first perspective may be a 3D perspective, and the second perspective may be a 2D perspective. In such embodiments, the 2D perspective may be used to provide an overview over a larger area, and the 3D perspective may be used to provide an intuitive image of surroundings of a user.

The first perspective may be a perspective from an elevation angle smaller than an elevation angle of the second perspective. In this respect, an elevation angle of 90° corresponds to a vertical down-view, i.e., essentially a 2D perspective, while an elevation angle of 0° corresponds to a view from ground-level.

A border region between the first portion and the second portion may be displayed with a perspective gradually varying from the first perspective to the second perspective to provide a smooth change from the first map portion to the second map portion.

The second map portion may be a map portion showing the immediate surroundings of a user.

A route a user is to take may be displayed extending from the second map portion to the first map portion and/or vice versa. Therefore, both map portions may be used for showing a route, for example, in a navigation system.

The displayed route may be displayed in a manner that it remains at least partially visible even if hidden by map elements in the respective perspective. For example, a semi-transparent portion may be displayed above the route in case of a 3D perspective.

Elements providing additional information may be displayed, such as for example elements relating to music reproduction such as receiving radio stations or playing compact discs or MP3 songs or internet information.

A navigation system according to an aspect of the present invention comprises a display, a processing unit and a map memory storing at least one map. The processing unit is configured to display a first portion of a map stored in the map memory on the display using a first perspective and simultaneously displaying a second portion of the map stored in the map memory using a second perspective. Through displaying different portions of a map with different perspectives, advantages of different perspectives may be combined.

It is to be noted that the term “navigation system” applies both to navigation systems fixedly built in a vehicle and to mobile navigation systems. Moreover, the term not only applies to dedicated navigation systems, but also to multi-purpose devices usable as navigation systems. For example, many modern mobile phones may be used as navigation systems. The term “navigation system” may not only apply to land based systems, but also to nautical and aeronautical systems.

The first and second portions may be adjacent to each other in the map and may be displayed adjacent to each other on the display. In this case, the first portion and second portion may essentially be used as a single map.

The first perspective may be a 3D perspective, and the second perspective may be a 2D perspective. In such embodiments, the first portion may provide an overview over a larger area, and the second portion to provide an image of the surroundings of a user of the navigation system. In other embodiments, the first perspective and the second perspective may for example both be 3D perspectives with different elevation angles.

The navigation system comprises a positioning device configured to determine a position of the navigation system. The processing unit may calculate a route from a current position of the navigation system to a destination position and to display at least part of the route on the first and second map portions. A display of the route may be continuous over the first and second map portions in such embodiments.

The route may be displayed in a manner to make the route discernable even when it is hidden by map elements like buildings. For example, a semi-transparent portion may be displayed on top of the route when the respective first or second perspective is a 3D perspective.

The processing unit may be configured to display additional elements providing additional information on the display.

These and other objects, features and advantages of the present invention will become apparent in light of the detailed description of the best mode embodiment thereof, as illustrated in the accompanying drawings. In the figures, like reference numerals designate corresponding parts.

### DESCRIPTION OF THE DRAWINGS

Embodiments of the invention will be described with reference to the accompanying drawings.

FIG. 1 is a block diagram of a navigation system;

FIG. 2 is a pictorial illustration of a map being displayed according to an aspect of the present invention;

FIG. 3 is a pictorial illustration of a map being displayed according to another aspect of the present invention;

FIG. 4 is a pictorial illustration of a map being displayed according to yet another aspect of the present invention;

FIG. 5 is a pictorial illustration of a map being displayed according to still yet another aspect of the present invention; and

FIG. 6 is a flow chart illustration of a method of automatically displaying map information according to an aspect of the present invention.

### DETAILED DESCRIPTION OF THE INVENTION

Embodiments of the invention will be described with reference to the drawings. It should be noted that features of different embodiments described may be combined with each other unless specifically stated otherwise.

In the following, various embodiments of navigation systems and methods for displaying maps thereon will be described. It should be noted that in the context of this application, the term “navigation system” not only relates to dedicated navigation systems, but also generally relates to devices usable as navigation systems. For example, many modern mobile phones or also computers may be used as navigation systems. The term “navigation system” not only applies to land based systems, but also to nautical and aeronautical systems Therefore, the term “navigation system” generally relates to any kind of electronic device that may assist a user in finding a way to a particular destination.

On such navigation systems, maps often may be shown on a corresponding display. The maps may be shown with a certain perspective, for example a two-dimensional perspective (2D) corresponding to a view directly from above or a three-dimensional (3D) perspective corresponding to a view from an acute viewing angle with respect to ground. The viewing angle with respect to ground is sometimes also referred to as elevation angle. Therefore, an elevation angle of 90° would correspond to a 2D perspective, i.e., a view from directly above, while an elevation angle of 0° would correspond to a view from ground level.

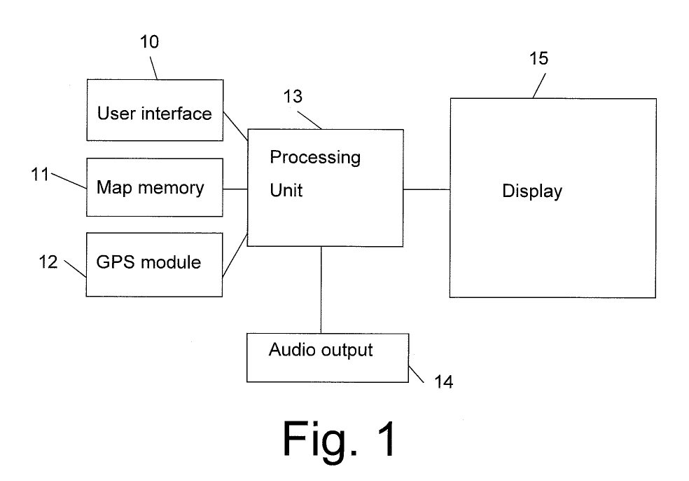

FIG. 1 is a block diagram of a navigation system, which comprises a user interface 10, a map memory 11, a GPS module 12, a processing unit 13, an audio output 14 and a display 15. The processing unit 13 controls and coordinates the user interface 10, the map memory 11, the GPS module 12, the audio output 14 and the display 15. The processing unit comprise for example one or more microprocessors, memory such as for example read only memory and/or random access memory, and/or logic circuitry to perform the functions described in the following.

The user interface 10 enables a user to input data into the device. The user interface 10 may for example comprise a voice interface, e.g., such that the navigation system reacts to spoken words from a user, and/or keys. In some embodiments, the display 15 may be touch-sensitive and in this respect also be part of or form the complete user interface 10, a user being able to input data by touching the display at appropriate places in this case. For example, a user may use the user interface 10 to input a desired destination.

In the map memory 11, one or more maps are stored. The map memory 11 may be any kind of storage device suitable for storing a map, and may for example comprise random access memory, flash memory, read only memory and/or data carriers such as for example CDs or DVDs. It should be noted that memory integrated circuits may be built in the navigation system, but may also be configured to be removable from the navigation system, for example in the form of memory cards. The GPS module 12 is an example for a positioning device and is configured to receive GPS signals and to determine a position of the navigation system. By using data from the one or more maps stored in the map memory 11 and the current position determined by the GPS module 12, the processing unit 13 may calculate a route to the above-mentioned destination input by a user via the user interface 10. The processing unit 13 then displays portions of the one or more maps stored in the map memory 11 together with at least a part of the calculated route on the display 15. In embodiments, as will be explained below in more detail, different portions of the map are displayed in different perspectives. For example, a portion of a map showing the surroundings of the navigation system may be displayed in a three-dimensional (3D) manner, whereas portions of the map relating to parts of the calculated route further away from the current destination may be displayed in a two-dimensional (2D) manner The portions displayed may be continuously updated based on a change of position as determined by the GPS module 12. In addition to displaying the route on the display 15, the processing unit 13 may also give directions to a user via the audio output 14, for example “turn right”, “turn left” and the like.

It should be noted that the diagram of FIG. 1 is only a schematic view showing elements helpful for the understanding of embodiments of the present invention, but is not to be regarded as an exhaustive showing of all possible elements of a navigation system. In particular, in case a navigation system is implemented as a multi-purpose device, for example a mobile phone or also a combined navigation system/music reproduction device, additional elements for implementing additional functions may be present. The term “navigation system” not only applies to land based systems, but also to nautical and aeronautical systems. Also, while the GPS module 12 is shown for determining the position of the navigation system, in other embodiments other components for determining the position may be additionally or alternatively present, for example devices for determining the position based on other satellite navigation signals like Galileo signals, for determining a position based on signals like mobile phone signals and/or for determining the position based on data from a vehicle were the navigation system is incorporated, for example speed data.

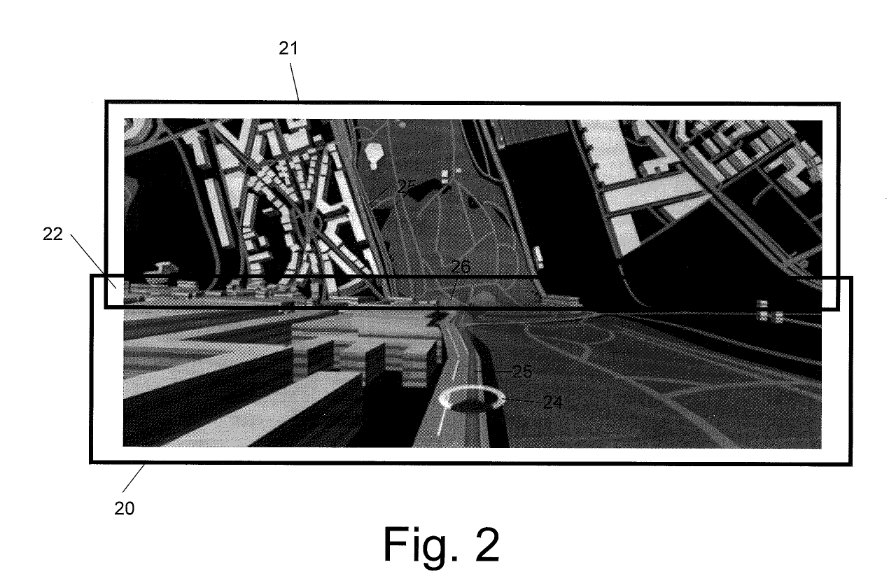

FIGS. 2-5 are various pictorial illustrations of different map portions with two different perspectives. These possibilities may for example be implemented in the system illustrated in FIG. 1, but are not restricted thereto and may generally be used in navigation systems.

FIG. 2 an illustrative example for a map being displayed in accordance with an aspect of the present invention. The map comprises a first portion 20 that is displayed in a three-dimensional manner and a second portion 21 displayed essentially in a two-dimensional manner. A portion 21 at a boundary between the first portion 20 and the second portion 21 is designed such that the perspective gradually changes, which gives the impression of a curve. In other words, in the portion 22 the elevation angle gradually changes from the elevation angle used for the portion 20, which may for example be between 5° and 40°, to the elevation angle used in the portion 21, which may be approximately 90°.

A portion of a route to be taken by a user of the navigation system to reach his or her destination is generally labelled 25 and is shown both in the first portion 20 and in the section portion 21. As the first portion 20 and second portion 21 are provided in a seamless, merged manner adjacent to each other, the route to be taken can be tracked over the whole display.

Furthermore, as a cursor 24 the location of the navigation system, which corresponds to a location of a vehicle incorporating the navigation system in the example shown, is depicted.

In particular in the first portion 20, e.g., the 3D portion, it may happen that the route 25 is “hidden” behind map elements like buildings. To make the route visible also in such instances, in the example of FIG. 2 a “glow” 26, i.e., a semi-transparent portion 26, is provided “above” the route 25, where the glow 26 remains visible behind for example buildings such that at least the approximate course of the route can be discerned.

Referring still to FIG. 2, as the position of the navigation system is marked by the cursor 24 changes, the map portions displayed also change. For example, when the cursor 24 moves along the route 25, the map portion may change accordingly, such that the surroundings of the cursor 24 are always shown in the first portion 20 in a three-dimensional manner, and portions further away on the route 25 are shown in the second portion 21 in a two-dimensional manner.

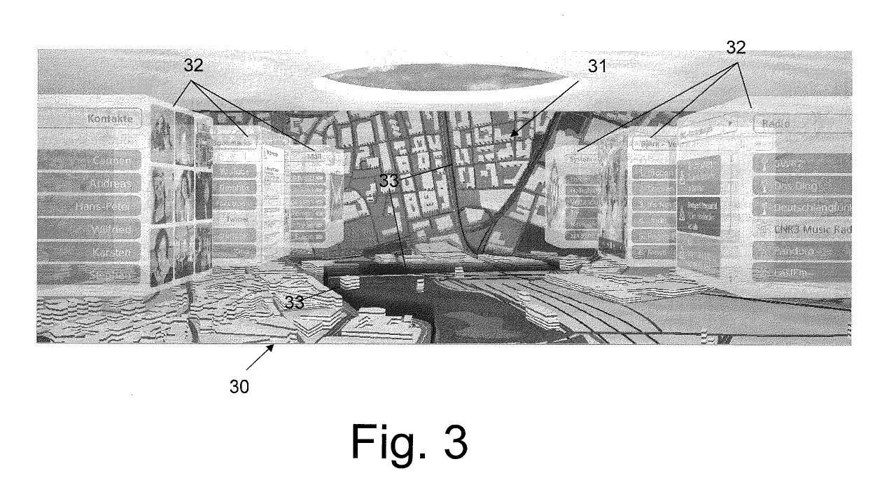

In the example illustrated in FIG. 2, only the map portions together with the route are displayed. In other embodiments, additional information may be shown on a display. An illustrative example for such additional information is shown in FIG. 3.

In FIG. 3 a first portion 30 of a map is shown in a three-dimensional manner, and a second portion 31 of the map is shown in a two-dimensional manner, the first portion 30 and the second portion 31 being adjacent to each other and are merged at their boundaries in a seamless manner. A route 33 to be taken is also shown, with a “glow” as explained with reference to FIG. 2 being added above the route. Cubes 32 are illustrated which provide additional information, for example regarding radio stations, music being reproducible for example from CDs or from stored MP3 files, system information and internet information, information regarding contacts and information regarding mail or other internet services. These types of information only serve as examples, and any desired information may be depicted.

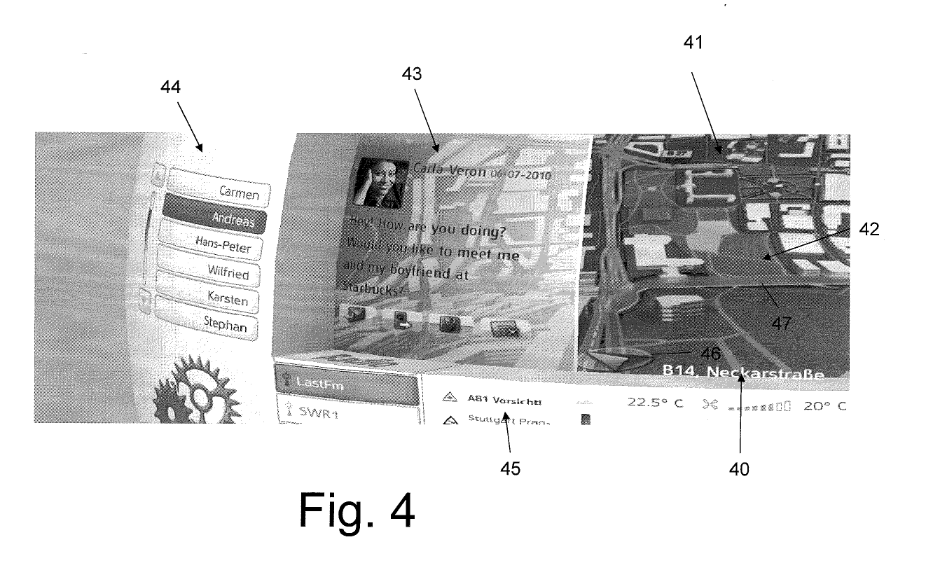

An example of displaying map portions is illustrated in FIG. 4, where a first portion 40 is displayed in a three-dimensional manner, and a second portion 41 is displayed in a two-dimensional manner. In the example illustrated in FIG. 4, a transition between the first portion 40 and the second portion 41 in a region labelled 42 is comparatively slow, i.e., the change of perspective gradually extends over a larger area than for example in FIG. 2 or 3, giving the impression of a rather large radius for the change.

In the display as shown in an illustrative manner in FIG. 4, besides the map at a lower portion 45 for example traffic information, information regarding temperature and information regarding a received radio station are shown, and in a portion 44 left of the map contacts are shown. Furthermore, a portion 43 overlays the map in a semi-transparent manner and is used for showing a received message, for example a SMS (Short Message Service).

In first map portion 40 and second map portion 41, a route 47 is shown, and a cursor 46 shows a current position of the navigation system, which corresponds to a position of a vehicle incorporating the navigation system.

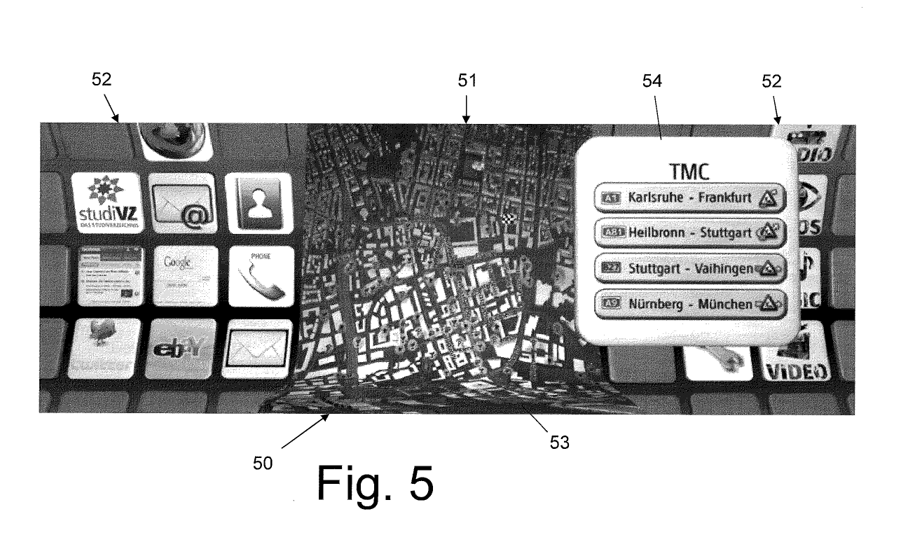

FIG. 5 is a pictorial illustration of a map being displayed according to still yet another aspect of the present invention. At a first portion a first map portion 50 is shown in a three-dimensional manner with a low elevation angle, for example, an elevation angle between about 5° and 40°. A second map portion 51 in this case is also shown in a three-dimensional perspective, with a higher elevation angle, for example an elevation angle in the range between about 60° and 90°, preferably between about 70° and 85°.

Moreover, in the example of FIG. 5 the size of the second portion is considerably larger than the size of the first portion, whereas for example in the example of FIG. 4 the size of the first portion exceeds the size of the second portion, to give an example for different positioning between first portion and second portion, which positioning can be chosen in any desired manner A route 53 to be taken is shown in the first portion 50 and the second portion 51 in FIG. 5.

On both sides of the first map portion 50 and the second map portion 51, additional information 52 is shown in the form of tabs on an imagined cylindrical surface. The additional information may for example relate to internet, e-mail, phone calls, radio station, music reproduction, video reproduction or system information. In addition, an overlay 54 shows traffic information.

As can be seen from the examples shown in FIGS. 2-5, different map portions with different perspectives may be displayed in a variety of manners. It is also to be noted that the examples shown are not exhaustive, and other arrangements are equally possible.

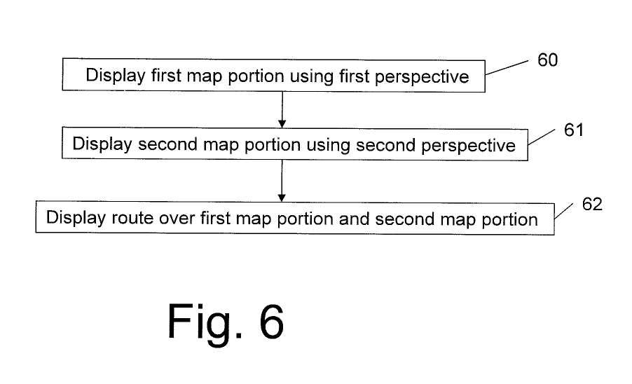

FIG. 6 is a flow chart illustration of a method of automatically displaying map information according to an aspect of the present invention. In step 60 a first map portion using a first perspective is displayed. The first perspective may be a 3D perspective, in particular a 3D perspective with an elevation angle between about 5° and 40°. In step 61, simultaneously a second map portion using a second perspective is displayed. The second perspective may use an elevation angle higher than the elevation angle of the first perspective, for example an elevation angle between about 60° and 90°, where 90° corresponds to a 2D perspective. The first map portion and the second map portion may be displayed merging at a common border, optionally with a transition region where the perspective gradually changes. In step 62, a route is displayed over the first map portion and the second map portion.

Although the present invention has been illustrated and described with respect to several preferred embodiments thereof, various changes, omissions and additions to the form and detail thereof, may be made therein, without departing from the spirit and scope of the invention.

What is claimed is:

1. A method for displaying a map on a navigation system, comprising:
displaying a first portion of a map on a display using a first perspective; and
displaying a second portion of the map the display using a second perspective different from the first perspective, where the steps of displaying the first portion and the second portion are performed simultaneously.

2. The method of claim 1, where the first perspective has an elevation angle of view smaller than an elevation angle of view of the second perspective.

3. The method of claim 2, where the second perspective comprises a two-dimensional perspective.

4. The method of claim 1, where the first map portion and the second map portion are adjacent map portions in the map and are displayed adjacent to each other in the display.

5. The method of claim 4, where the first map portion and the second map portion are merged in a seamless manner at a common border.

6. The method of claim 5, where a perspective gradually changes from the first perspective to the second perspective at the common border.

7. The method of claim 1, further comprising displaying at least part of a route in the first map portion and the second map portion.

8. The method of claim 7, where the step of displaying the part of the route comprises displaying the route with a marking portion displayed above the route to make the route discernable when hidden by map elements.

9. The method of claim 1, further comprising displaying additional elements providing additional information to a user.

10. A navigation system, comprising:
memory configured to store a map;
a processing device; and
a display;
where the processing device simultaneously displays a first portion of the map stored in the map memory using a first perspective and a second portion of the map using a second perspective different from the first perspective on the display.

11. The system of claim 10, where the first perspective has an elevation angle of view smaller than an elevation angle of view of the second perspective.

12. The system of claim 10, where the first map portion and the second map portion are adjacent map portions in the map, and the processing device is configured to display the first map portion and the second map portion adjacent to each other and merged in a seamless manner at a common border on the display.

13. The system of claim 12, where the processing unit is configured to display the first map portion and the second map portion with a gradually changing perspective at the common border.

14. The system of claim 10, further comprising a positioning device configured to determine a position of the navigation system, wherein the processing unit is further configured to calculate a route to a destination based on the map and the determined position and to display at least part of the route in the first map portion and the second map portion.
